(19) United States
(12) Patent Application Publication
(10) Pub. No.: US 2012/0291208 A1
(43) Pub. Date: Nov. 22, 2012

(54) DUAL-FUNCTION LINT BRUSH AND VIBRATOR DEVICE

(76) Inventor: Drew Roger Edwards, New York, NY (US)

(21) Appl. No.: 13/113,043

(22) Filed: May 21, 2011

(51) Int. Cl. A47L 25/00; A61H 23/00

(52) U.S. Cl. 15/104.002

(57) ABSTRACT

A dual-function device embodying a functional, conventional lint roller style of lint brush, but with a hollow outer casing that houses a conventional vibrator for sexual stimulation. The hollow outer casing is composed of two molded plastic halves that assemble together to conceal a vibrator placed within. The dual-function aspect is in order to camouflage the vibrator aspect of the present invention in order to avoid embarrassment for the user.

### FIELD OF THE INVENTION

The present invention relates to camouflaging vibrator devices used for therapeutic sexual stimulation. It is a dual-function device, embodying a functional, conventional lint roller style of lint brush, but with a hollow outer casing that houses a conventional vibrator for sexual stimulation. The outer casing is made of two molded plastic halves that assemble together to conceal a vibrator placed within. The dual-function aspect is in order to camouflage the vibrator so as to avoid embarrassment for the user.

### BACKGROUND OF THE INVENTION

Although society has become much more open about intimate matters over the last few decades, most people who purchase vibrator devices for sexual stimulation don't want other people to know about it. Most people want to keep their private lives private, especially since there still remains a degree of societal ambivalence with regard to devices designed to produce sexual stimulation. Privately, people realize such devices are needful for human health and satisfaction, yet publicly people may feel the need to condemn them as hurtful to societal mores. Such ambivalence is understandable, though it can be painful for those who are its target. Not surprisingly, that target is usually women.

In matters sexual, as one writer put it, “certain segments of society still view the pleasure-seeking, self-pleasuring woman as either a bad girl or an object of ridicule.” Because of this line of thinking, many types of vibrators have been traditionally marketed to women as “camouflaged technologies.” Vibrating nail-buffer kits, backscratchers, and even attachments for vacuum cleaners were sold to women who would be too ashamed to purchase a device sold specifically for sexual stimulation. Even today, the very popular Hitachi Magic Wand™ is marketed as a muscle relaxer, despite its widespread reputation as a vibrator for sexual stimulation. People want and need vibrators; but they also want and need to camouflage them. Such is the aim of the present invention, which follows in the line of previous inventions listed below.

U.S. Patent application 2007/0244418 filed by Harkness on Oct. 18, 2007 is for a vibrator with multiple removable attachments, one of which is a functional electric toothbrush, that camouflage the vibrator function. The present invention is similar to Harkness in that it also camouflages the vibrator, but differs in that the present invention encloses the vibrator within the outer casing, of a conventional lint roller style of lint brush.

U.S. Pat. No. 7,351,215 issued to Roberts on Apr. 1, 2008 is for a dual-compartment, dual-function cosmetic container and vibrator device. Roberts incorporates a fully functional vibrator, also known as a vibrating egg, into the lower portion of a conventional compact cosmetic container, giving the device its dual functions. The present invention also camouflages its vibrator function, but differs from Roberts by concealing the vibrator within the outer casing of a conventional lint roller style of lint brush.

U.S. Pat. No. 5,688,063 issued to Yu et al. on Nov. 18, 1997 is for a writing apparatus with a vibrator. Yu et al. combine a conventional writing instrument with a vibrator at the top end of the device, thus camouflaging the vibrator function. The present invention differs from Yu et al. in that the present invention hides a conventionally sized and shaped vibrator device within the outer casing of a conventional lint roller style of lint brush.

### SUMMARY OF THE INVENTION

The present invention is a conventional lint roller style of lint brush, herein referred to as a lint roller brush, that conceals a vibrator device designed for sexual stimulation. A lint roller brush employs a roll of one-sided adhesive paper, herein referred to as lint roller tape, which mounts on an outer casing that has a spindle with an attached handle, and facilitates the removal of lint and other small fibers from materials such as clothing, upholstery and linen. Once expended, the roll of lint roller tape can typically be replaced with a new roll. The design of the lint roller brush enables fast, 360 degree rotation of the lint roller tape, facilitating the easy removal of lint and other small fibers. Lint roller brushes are especially popular among pet owners for removing dog and cat hair from fabrics, carpets, etc.

The present invention combines a conventional lint roller brush, as described above, with a conventional vibrator designed for sexual stimulation. The vibrator is concealed within the interior of the lint roller brush. The lint roller brush is designed with a hollow outer casing, divided into two molded plastic halves along the vertical axis, that opens up to reveal the vibrator and closes to conceal it. Once the two halves of the outer casing are assembled together, the user can mount a conventional roll of lint roller tape onto the outer casing to make a lint roller brush, which can then be rolled over clothes or other material to pick up lint or other small fibers. When the outer layer of the lint roller tape becomes dirty or is no longer sticky, the outer layer of the lint roller tape can be peeled off to reveal a fresh layer underneath. Rolls of conventional lint roller tape, in a standard size that will fit the present invention, are readily available for purchase at both online and brick-and-mortar stores.

The molded plastic halves that assemble together to form the outer casing are designed of a width and length sufficient to house a traditional “slim-line” sized and shaped vibrator. The preferred embodiment of the present invention envisions the outer casing sold in conjunction with the vibrator, and with one or more rolls of lint roller tape. Another embodiment of the present invention is envisioned as the outer casing sold without a vibrator, which would need to be purchased separately. Additional embodiments envision functional hair brushes, flashlights, and TV remote control devices that can store a conventional vibrator within their interiors. A further embodiment contemplates a mini or travel size lint roller brush that would house a “bullet” style vibrator egg.

### DESCRIPTION OF THE DRAWINGS

FIG. 1 shows sidelong views of the molded plastic halves that will be used in assembling the outer casing of the lint roller brush.

FIG. 2 shows front views, from a downward angle, of the molded plastic halves, including the clip and receptor that snap together to tightly assemble the molded plastic halves.

FIG. 3 shows one of the molded plastic halves with a vibrator seated inside it.

FIG. 4 shows the exterior of the outer casing, made up of the two molded plastic halves assembled, together.

FIG. 5 shows the exterior of the lint roller brush, with the lint roller tape mounted upon the outer casing.

### DETAILED DESCRIPTION OF THE INVENTION

The present invention is a functional lint roller brush (5) with an interior designed to conceal a conventional vibrator (10) for use in sexual stimulation. The present invention is thus a dual-function “camouflaged technology” that serves as a conventional lint roller brush (5) while concealing the vibrator (10) within its outer casing (7).

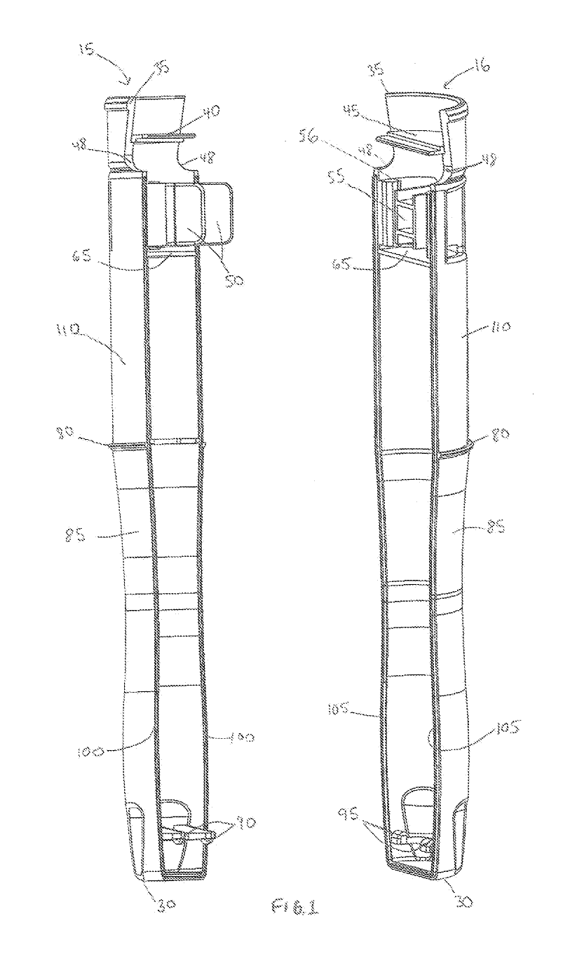

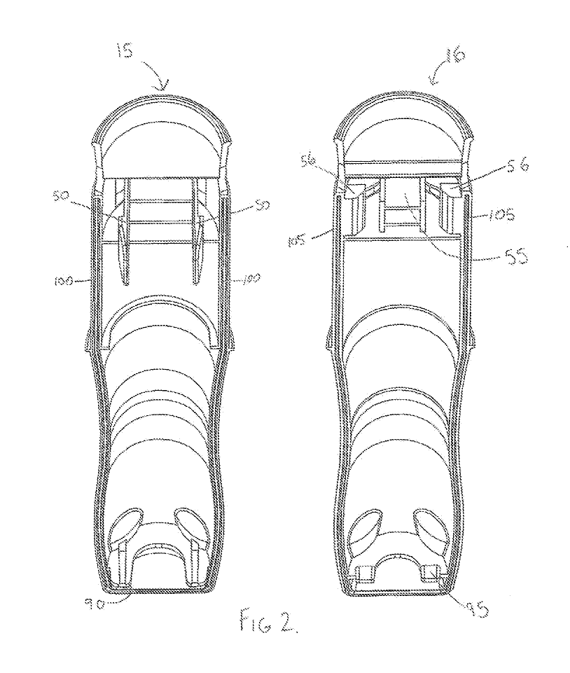

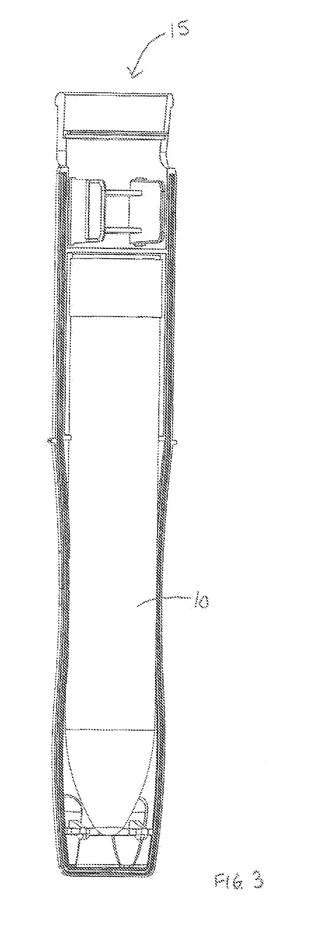

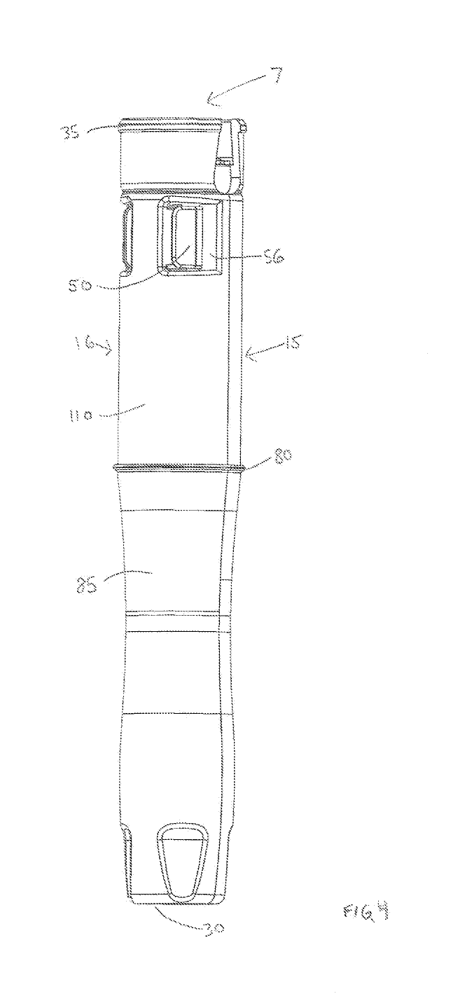

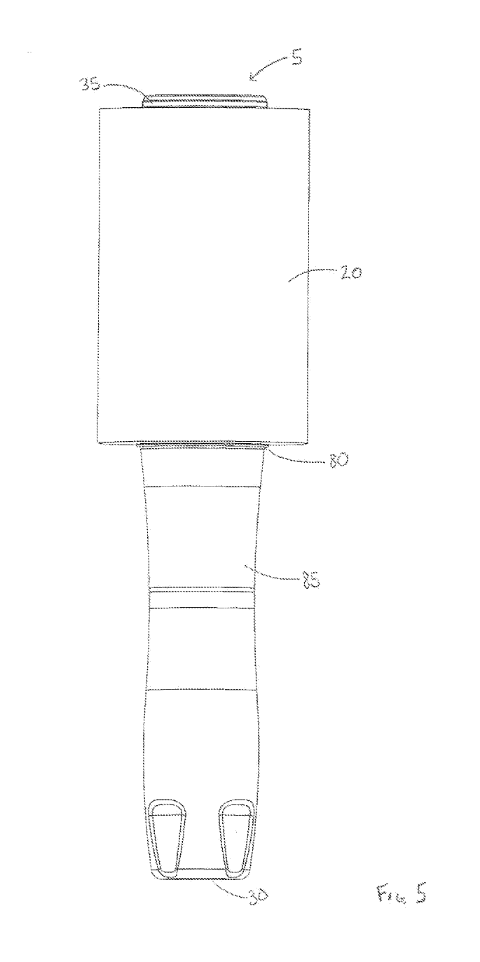

FIG. 1 shows a side view of the “clip” molded plastic half (15) that will be assembled together with the “receptor” half (16) to form the outer casing (7) (see FIG. 4). Examining the clip molded plastic half (15) from summit ridge (35) to base tip (30), we can see the following features. The summit ridge (35) and midpoint ridge (80) serve the function of keeping the lint roller tape (20) (see FIG. 5) on the spindle (110) of the present invention while also allowing the lint roller tape (20) (see FIG. 5) to roll freely in order to pick up lint. The spindle (110) is the area from the summit ridge (35) to the midpoint ridge (80) on which the lint roller tape (20) (see FIG. 5) is placed. Below the summit ridge (35) are two half-circles (40 clip half and 45 receptor half) that are slightly offset from each other, so that when the two molded plastic halves (15) and (16) are assembled together to form the outer casing (7) (see FIG. 4), the half-circles (40 and 45) will interconnect to help keep together the joined molded plastic halves (15) and (16). The circle formed by the two half-circles (40 and 45) also blocks the vibrator (10) (see FIG. 3) and clip mechanism (55) & (56) (see FIG. 2) from view, which is key to the camouflage aspect of the present invention. Directly next to the half-circles (40 and 45), on the exterior of the both molded plastic halves, (15) and (16), are two indentations (48). These indentations (48) allow the user to compress the edges of the summit ridge (35) in order to mount or remove the lint roller tape (20) (see FIG. 5) from the spindle (110). Slightly below the half-circles (40 and 45) are one set of identical outward facing clips (50) and a receptor (55) that guides and receives the clips during assembly. Two identical tapered protrusions (56) (see FIG. 2) compress the outward facing clips until they pass over the flat portion of the protrusion slightly beyond the tapered portion. The set of identical outward facing clips (50) remain in their natural position (non-compressed) over the flat portion of the protrusion (56) (see FIG. 2) until the clips (50) are compressed by the user and the two molded plastic halves pulled apart.

Continuing downward from the set of identical outward facing clips (50) and receptor (55), there is a semi-circle (65). When the two molded plastic halves (15) and (16) are assembled together, the semi-circles (65) will join to form a circle that serves as a containment edge for the vibrator (10) (see FIG. 3). Moving downward further, there is the midpoint ridge (80) that serves as the base of the spindle (110) on which will be placed the lint roller tape (20) (see FIG. 4). The midpoint ridge (80) also serves as the summit of the handle (85) of the present invention. The handle (85) is the area from the midpoint ridge (80) to the base tip (30), and will be grasped by the user when employing the present invention in its lint roller brush function. Near the base tip (30) of the molded plastic half with the clip (15) is a set of over latches (90) and near the base tip (30) of the molded plastic half with the receptor (16) is a set of under latches (95). The set of over latches 90) of one molded plastic half (15) will slide over the set of under latches (95) on the other molded plastic half (16), to interlock the two molded plastic halves (15) and (16) together to form and secure tightly the outer casing (7) (see FIG. 3). Of further note is the design of the ridge protrusion (105) that runs the perimeter of the contact edges on the receptor half (16) from the bottom of the indention (48) to the base tip (30). This ridge protrusion (105) fits inside the canal groove (100) that runs the perimeter of the contact edges of the clip half (15) from the bottom of the indention (48) to the base tip (30). Once assembled, the ridge (105) and canal groove (100) serve to not permit lateral movement of the two molded plastic halves (15) and (16).

FIG. 2 shows the front view of both plastic halves (15) and (16) angled in toward the reader, similar to a view looking down on the plastic halves from above. The clips (50) on the plastic half (15) are spaced in a manner to allow them to pass by the receptor (55) on the plastic half (16) and be compressed inward by the tapered portion of the protrusions (56). Once the clips (50) have slid past the protrusions (56), they remain locked in place by the flat outward facing portion of the protrusion.

FIG. 3 shows the molded plastic half with clips (15) with a vibrator (10) placed inside it. The vibrator (10) can be any conventional, commercially available device of a size that will fit inside the present invention. After the vibrator (10) is placed inside the molded plastic half (15), the second molded plastic half with receptor (16) will be attached to the first molded plastic half (15), concealing the vibrator (10) within the two molded plastic halves (15) and (16). When the two molded plastic halves (15) and (16) are assembled together, they form the outer casing (7) (see FIG. 4).

FIG. 4 shows the outer casing (7) formed by fitting together the two molded plastic halves (15) and (16) to conceal the vibrator (10) (see FIG. 3). Examining the outer casing (7), we see the summit ridge (35) of the outer casing (7), which is also the summit ridge (35) of the spindle (110). The spindle (110) stretches from the summit ridge (35) to the midpoint ridge (80) of the outer casing (7). It is on the spindle (110) that the lint roller tape (20) (see FIG. 5) will be placed. From the midpoint ridge 80) to the base tip (30) is the handle (85), which the user will hold while using the present invention in its lint roller brush function.

FIG. 5 shows the lint roller brush (5) after it has been assembled and the lint roller tape (20) has been placed on the spindle (110) (see FIG. 4). The lint roller tape (20) is a conventionally known, standard size roll of one-sided adhesive paper that is readily available for purchase at both online and brick-and-mortar stores. The lint roller tape (20) is mounted onto the spindle (110) (see FIG. 4) via the summit ridge (35), and extends from the summit ridge (35) down to the midpoint ridge (80) of the lint roller brush (5). From the midpoint ridge, (80) to the base tip (30) is the handle (85) of the lint roller brush (5). As shown in FIG. 5, the present invention is now a fully functional lint roller brush (5) that also conceals a vibrator (10) (see FIG. 3).

What is claimed is:

1. A dual-function device, embodying:
a functional, conventional lint roller style of lint brush, but with a hollow outer casing that houses a traditional style vibrator for sexual stimulation.

2. The dual-function device of claim 1, wherein:
said conventional lint roller style of lint brush is deconstructed to reveal the traditional vibrator inside by first removing adhesive paper roll from the spindle portion of the handle and then separating the two halves down the vertical axis.

3. The dual-function device of claim 2, wherein:
said two halves snap tightly together with no void or space present between the two halves once assembled, in order to maintain the camouflage state of the vibrator inside.

4. The dual-function device of claim 1, wherein:
said hollow casing has an inside cavity that is shaped to contour to a traditional size vibrator to eliminate excess movement of the vibrator within the hollow casing.

5. The dual-function device of claim 1, wherein:
said conventional lint roller style of lint brush utilizes a spindle diameter that allows standard size adhesive paper rolls to fit onto said spindle and rotate freely.

6. The dual-function device of claim 1, further comprising:
a set of clips extending out of the inside cavity of one half of said hollow outer casing that align and snap together with a receptor that is formed within the inside cavity of the remaining half of said hollow outer casing.

7. The dual-function device of claim 6, wherein:
said set of clips have a ridge on the distal tip similar in shape to the lateral half of an arrow head;
wherein said ridge locks into place by moving beyond the flat side of the receptor and not being permitted to move backward once resting on the receptor's flat wall.

8. The dual-function device of claim 1, further comprising:
a set of latches formed into both halves of the inside cavity-toward the bottom of said hollow outer casing.

9. The dual-function device of claim 8, wherein:
said set of latches interlock via an upward facing round hump on the distal end of the latches found in one half of said hollow outer casing passing over a downward facing round hump on the distal end of the latches found in the remaining half of said hollow outer casing.
